(19) United States
(12) Patent Application Publication
(10) Pub. No.: US 2012/0145620 A1
(43) Pub. Date: Jun. 14, 2012

(54) Filter with Dissolvable Seal

(75) Inventor: John Beard, Kearney, NE (US)

(73) Assignee: Baldwin Filters, Inc., Kearney, NE (US)

(21) Appl. No.: 12/962,756

(22) Filed: Dec. 8, 2010

(51) Int. Cl. B01D 35/00

(52) U.S. Cl. 210/205

(57) ABSTRACT

A filter apparatus is provided. The filter includes a filter element that carries an additive for the treatment of coolant filtered by the filter. The additive is contained within an additive chamber. A dissolvable seal is positioned over an outlet of the filter to prevent the undesirable leakage of additive during non-operation.

### FIELD OF THE INVENTION

This invention generally relates to coolant filters, and more specifically to coolant filters that incorporate an additive for the treatment of coolant.

### BACKGROUND OF THE INVENTION

Coolant filters containing additives for the treatment of coolant are generally known in the art. An example of such a filter can be found at U.S. Pat. No. 5,948,248 to Brown and assigned to the instant assignee, the entire disclosure of which is hereinafter incorporated by reference thereto. As described therein, an additive is contained within the filter, and introduced to the coolant during the filtration process. The invention generally relates to improvements over these designs. These and other advantages of the invention, as well as additional inventive features, will be apparent from the description of the invention provided herein.

### BRIEF SUMMARY OF THE INVENTION

In one aspect, the invention provides a filter incorporating an additive and a seal preventing inadvertent leakage of the additive prior to installation of the filter. A filter according to this aspect includes a filter element having filter media and defining a flow path through the filter media. A dissolvable seal is positioned to close the flow path through the media.

The filter element defines an additive chamber that carries the additive. The additive chamber extends between an open end cap and a closed end cap of the filter element. The dissolvable seal is disposed within the additive chamber.

In another aspect, the flow path extends through the additive chamber. The dissolvable seal closes the flow path from within the additive chamber. The end cap includes an outlet extending therethrough and in fluid communication with the additive chamber. The outlet is disposed along the flow path with the dissolvable seal sealing the outlet.

The outlet extends through inner and outer surfaces of the open end cap. The inner surface defines a boundary of the additive chamber with the dissolvable seal sealingly engaging the inner surface of the open end cap.

In another aspect, the dissolvable seal is configured to dissolve upon exposure to engine coolant. In one embodiment the dissolvable seal is configured to dissolve upon exposure to engine coolant in less than or equal to about five minutes.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a front cross sectional view of a filter apparatus according to the teachings of the present invention;

FIG. 2 is a front cross sectional view of a filter element of the filter apparatus of FIG. 1; and

FIG. 3 is a top view of the filter apparatus of FIG. 1.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

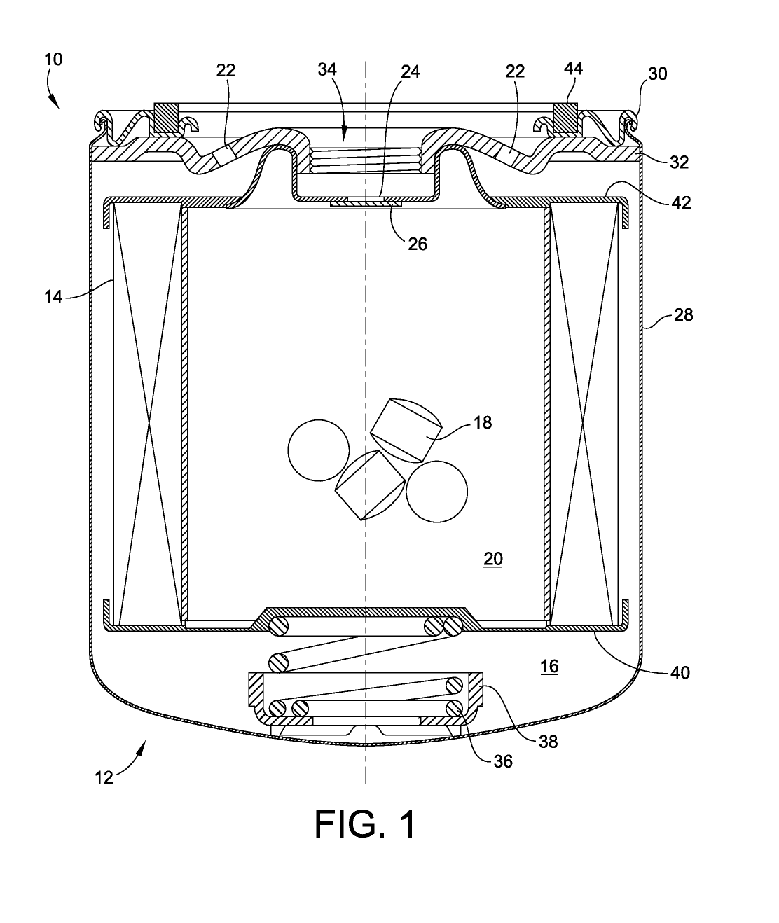

Turning now to the drawings, there is illustrated in FIG. 1 an exemplary embodiment of a filter cartridge 10. The filter cartridge 10 has a housing 12 that carries a filter element 14 within an interior 16 of the housing 12. The filter element 14 advantageously incorporates an additive 18 for the treatment of coolant filtered by the filter cartridge 10. While the following description will describe benefits and advantages of various inventive aspects as they apply to a filter cartridge, it will be recognized that these same benefits and advantages apply equally to filters generally, that may be embodied as a filter cartridge that includes a housing and a filter element, or a stand alone filter element.

Turning now to FIG. 3, the filter cartridge 10 has a plurality of ports 22 that define an inlet for coolant to enter the filter cartridge 10. Once the coolant enters the ports 22 it is filtered by the filter element 14 (see FIG. 1) and also treated with additive 18 (see FIG. 1) before exiting an outlet 24 of the filter cartridge 10. However, prior to operation (e.g. during storage and/or shipment) the outlet 24 is sealed using a seal element 26 so as to prevent undesirable leakage of the additive 18 contained within an additive chamber 20 of the filter cartridge 10.

The filter element 14 is contained within a canister shaped body 28 of the housing 12. The filter element is sealed within the body 28 using a lid 30 that is mounted to the body 28 using a roll seam. The lid 30 also carries a seal 44 to seal the filter cartridge 10 against a sealing surface.

A base plate 32 is affixed to an underside of the lid 30. The base plate 32 has a threaded connection 34 to facilitate the connection of the filter cartridge 10 to an internal combustion engine or other similar system. As illustrated in FIG. 1, the base plate 32 also provides the plurality of ports 22 that define an inlet of the filter cartridge 10.

A biasing member 36 is positioned within the chamber 16 of the housing 12 to bias the filter element 14 into sealing engagement with the base plate 32. The biasing member 36 is seated within a cup shaped seat 38 and contacts a closed end cap 40 of the filter element 14 to bias an open end cap 42 of the filter element 14 into the base plate 32 as illustrated.

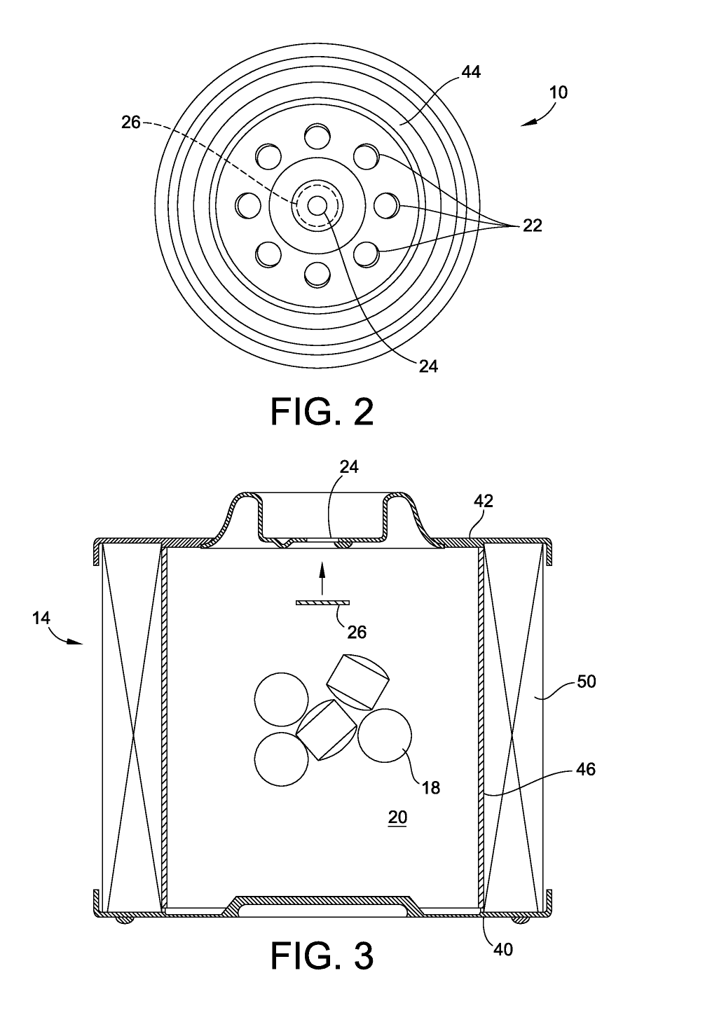

Referring now to FIG. 2, the filter element 14 has a ring of filter media 50 encapsulated between a closed end cap 40 and an open end cap 42. The filter media 50 may be pleated media, or any other filtration media ideal for the filtration of engine coolant. A center tube 46 extends along the interior diameter of the ring of filter media 50 and between the closed and open end caps 40, 42 to generally support the media 50 and reduce the likelihood that the same will collapse under pressure during operation.

The center tube 46 is generally cylindrical, and the end caps 40, 42 and center tube 46 together define the additive chamber 20. It is recognized, however, that in other embodiments, the center tube 46 can be omitted entirely, and the filter media 50 and end caps 40, 42 will define an additive chamber 20 for receipt of the additive 18.

The seal element 26 is also disposed within the additive chamber 20 and seals the outlet 24 from within the additive chamber 20 (see also FIG. 2). By housing the seal element 26 internally within the additive chamber 20, the same is prevented from inadvertent dislodgment prior to use of the filter cartridge 10. The seal element 26 has an adhesive portion to facilitate a tight seal of the outlet 24. However, in other embodiments, the seal element 26 may be provided on the other side of the open end cap 42, i.e. externally on the filter element 14, or over the threaded outlet 34 (see FIG. 1).

The seal element 26 is dissolvable such that when the filter cartridge 10 is installed and coolant filtered therethrough the seal element 26 will dissolve to allow coolant to pass through the filter cartridge 10. In one embodiment, the dissolvable seal is disc shaped with a diameter of about ⅜ inch. The outlet 24 is also circular shaped and has a diameter of about 5/32 inch. As such, there is a sufficient amount of overlap of the dissolvable seal element 26 over the outlet 24 to ensure that the dissolvable seal element 26 remains in place until it is dissolved. However, in other embodiments, the seal and/or the outlet 24 may have different dimensions and the invention is not limited to those described above.

In one embodiment, the seal element 26 is water soluble, and capable of dissolving in engine coolant in approximately less than about 5 minutes. Once dissolved, the seal material will disperse throughout the engine coolant and not affect the performance thereof. It will be recognized, however, that other seals can be utilized that dissolve in less or more time. As one example, the seal 26 may be formulated to immediately dissolve under the introduction of engine coolant.

Another advantage of the above configuration is achieved by way of containing the additive 18 directly within the additive chamber 20 of the filter element 14 as opposed to an additional chamber. Such a configuration presents the advantages of enhanced engine coolant filtration and treatment in a relatively compact design. Further, the seal element 26 advantageously prevents the undesirable leakage of additive 18 through the outlet 24 of the filter cartridge 10 prior to installation and operation of the filter cartridge 10.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A filter, comprising:
a filter element having filter media and defining a flow path through the filter media; and
a dissolvable seal positioned to close the flow path through the media.

2. The filter of claim 1, wherein the filter element defines an additive chamber carrying an additive, the dissolvable seal disposed within the additive chamber.

3. The filter of claim 2, wherein the additive chamber extends between an open end cap and a closed end cap of the filter element.

4. The filter of claim 3, wherein a center tube extends between the open and closed end caps, the center tube, open end cap, and close end cap bounding the additive chamber.

5. The filter of claim 2, wherein the flow path extends through the additive chamber, the dissolvable seal closing the flow path from within the additive chamber.

6. The filter of claim 5, wherein the open end cap includes an outlet extending therethrough and in fluid communication with the additive chamber, the outlet disposed along the flow path, the dissolvable seal sealing the outlet.

7. The filter of claim 6, wherein the outlet extends through inner and outer surfaces of the open end cap, the inner surface defining a boundary of the additive chamber, the dissolvable seal sealingly engaging the inner surface of the open end cap.

8. The filter of claim 7, wherein the dissolvable seal is larger than the outlet such that the seal overlaps the outlet.

9. The filter of claim 1, wherein the filter element includes an outlet disposed along the flow path, the dissolvable seal positioned over the outlet.

10. The filter of claim 9, wherein the filter element has a center axis, the outlet concentrically aligned with the center axis.

11. The filter of claim 10, wherein the outlet extends through an end cap of the filter element.

12. The filter of claim 11, wherein the end cap has an inner surface and an outer surface downstream along the flow path from the inner surface, the dissolvable seal sealingly engaging the inner surface.

13. The filter of claim 1, wherein the dissolvable seal is configured to dissolve upon exposure to engine coolant.

14. The filter of claim 13, wherein the dissolvable seal is configured to dissolve upon exposure to engine coolant in less than or equal to about five minutes.

15. The filter of claim 13, wherein the dissolvable seal has an outer diameter of about ⅜ inches, and the outlet has a diameter of about 5/32 inches.
